(19) United States
(12) Patent Application Publication
(10) Pub. No.: US 2015/0322922 A1
(43) Pub. Date: Nov. 12, 2015

(54) GENERATOR WITH STATOR SUPPORTED ON ROTOR

(71) Applicant: United Technologies Corporation, Hartford, CT (US)

(72) Inventor: Richard A. Himmelmann, Beloit, WI (US)

(21) Appl. No.: 14/366,438

(22) PCT Filed: Jan. 16, 2013
(86) PCT No.: PCT/US13/21715

§ 371 Date: Jun. 18, 2014

Related U.S. Application Data
(60) Provisional application No. 61/587,471, filed on Jan. 17, 2012.

(51) Int. Cl. F03D 11/00; F03D 9/00

(52) U.S. Cl. CPC F03D 11/0058; F03D 9/002

(57) ABSTRACT

A wind turbine comprises a support structure, a rotatable blade assembly, a generator rotor, a generator stator, and a torque control element. The support structure is located atop a tower. The rotatable blade assembly is supported by the support structure. The generator rotor is driven by rotation of the rotatable blade assembly. The generator stator is supported by bearings on the generator rotor. The torque control element extends between the support structure and the generator stator to secure the generator stator against rotation while allowing the generator stator to deflect with the generator rotor under aerodynamic loads.

### BACKGROUND

The present invention relates generally to direct drive generators for wind turbines, and more particularly to a generator wherein a stator is supported directly on a rotor.

Large-scale wind turbines use two to three airfoil blades mounted on a rotatable hub atop a high tower to drive at least one electric generator. Wind incident on the blades produces a torque which rotates the blades and hub about a central axis. Rotation of the blades and hub (collectively referred to as a blade rotor) produces a drive torque which turns a rotor, inducing flux through stator windings and producing electrical power. Some conventional wind turbines use doubly fed generators with wound rotors and wound stators, while others utilize permanent magnets in place of either rotor or stator windings.

Different types of generators use different mechanisms to transmit drive torque from the blade rotor to the generator rotor. Many conventional generators utilize speed-increasing gearboxes that convert low-speed, high-torque rotation at the blade rotor into high-speed lower-torque rotation at the generator rotor. Such gearboxes can be heavy, complex, and expensive to produce and maintain. Newer wind turbines often eschew gearboxes in favor of “direct-drive” arrangements wherein a driveshaft directly connects the blade rotor to the generator rotor.

Conventional direct drive wind turbine systems mount generator components directly to a stationary support structure. The driveshaft (and consequently the generator rotor) is rotatably mounted to the stationary support structure, while the stator is fixedly anchored to the stationary support structure. Driveshafts and stationary tower structures for direct drive generators are ordinarily constructed to be very rigid, so as to minimize driveshaft deflection under transient aerodynamic loads. To achieve this rigidity, stationary support structures are often heavily built and expensive.

Changes in wind profile (such as sudden gusts and rapid direction changes) exert non-axial forces on the blade rotor during ordinary wind turbine operation, causing the driveshaft to deflect angularly. This deflection has little effect on the position of the generator rotor relative to the generator stator in conventional gearbox-driven wind turbines, since gearboxes are usually configured to absorb driveshaft deflection, and generator rotor diameters in gearbox systems are usually relatively small. By contrast, generators for direct drive wind turbines typically have very large diameter rotors. These large rotor diameters (which may exceed 10 meters) allow direct-drive turbines to achieve high relative speeds between the generator rotor and stator without a gearbox, but exaggerate the effects of driveshaft deflection caused by aerodynamic loads. In particular, angular deflection of the driveshaft displaces the outer diameter of the rotor by an amount proportional to rotor diameter. Even small driveshaft deflections can therefore have a pronounced effect on the position of the generator rotor relative to the generator stator.

Contact between the rotor and stator can cause generator failure. To avoid contact from driveshaft deflection, direct drive generators typically have large air gaps which provide space for the rotor to deflect without touching the stator. Larger air gaps, however, reduce flux density and therefore generator efficiency, and necessitate increases to the overall size (and cost) of the generator.

### SUMMARY

The present invention is directed toward a wind turbine comprising a support structure, a rotatable blade assembly, a generator rotor, a generator stator, and a torque control element. The support structure is located atop a tower. The rotatable blade assembly is supported by the support structure. The generator rotor is directly attached to the rotatable blade assembly and is driven by rotation of the rotatable blade assembly. The generator stator is supported by bearings on the generator rotor. The torque control element extends between the support structure and the generator stator to secure the generator stator against rotation while allowing the generator stator to deflect with the rotor under aerodynamic loads.

### BRIEF DESCRIPTION OF THE DRAWINGS

FIG. 1 is a perspective view of the wind turbine of the present invention.

FIG. 2 is a close-up perspective view of the wind turbine of FIG. 1, depicting a generator and surrounding components.

FIG. 3 is a cross-sectional view of the wind turbine of FIG. 2.

FIG. 4 is a close-up perspective view of an alternative embodiment of the wind turbine of FIG. 1, depicting a generator and surrounding components.

FIG. 5 is a cross-sectional view of the wind turbine of FIG. 4.

### DETAILED DESCRIPTION

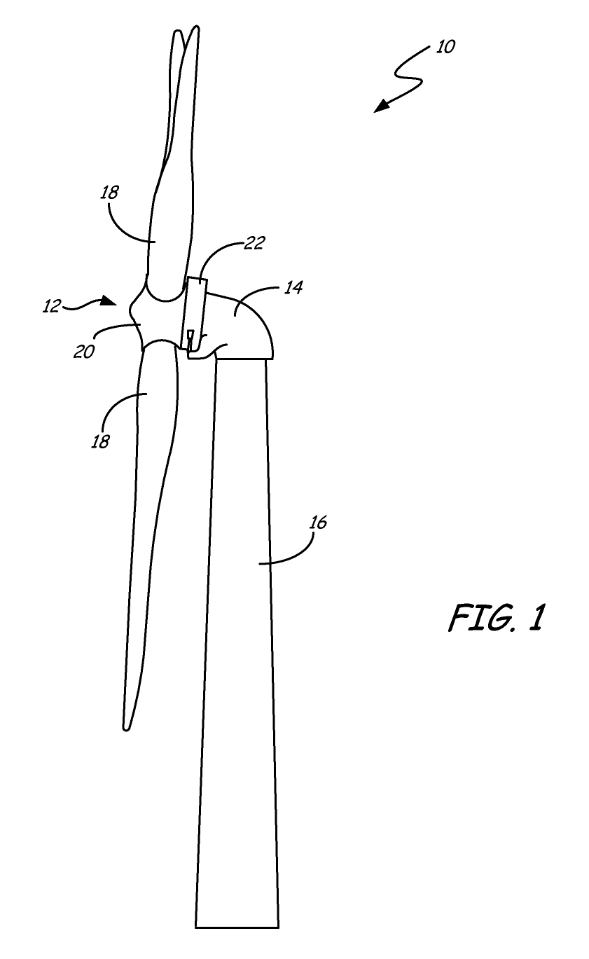

FIG. 1 provides a perspective view of one embodiment of a wind turbine according to the present invention. FIG. 1 depicts wind turbine 10, comprising blade assembly 12, support structure 14, tower 16, and generator 22. Blade assembly 12 is comprised of a plurality of blades 18 attached to hub 20.

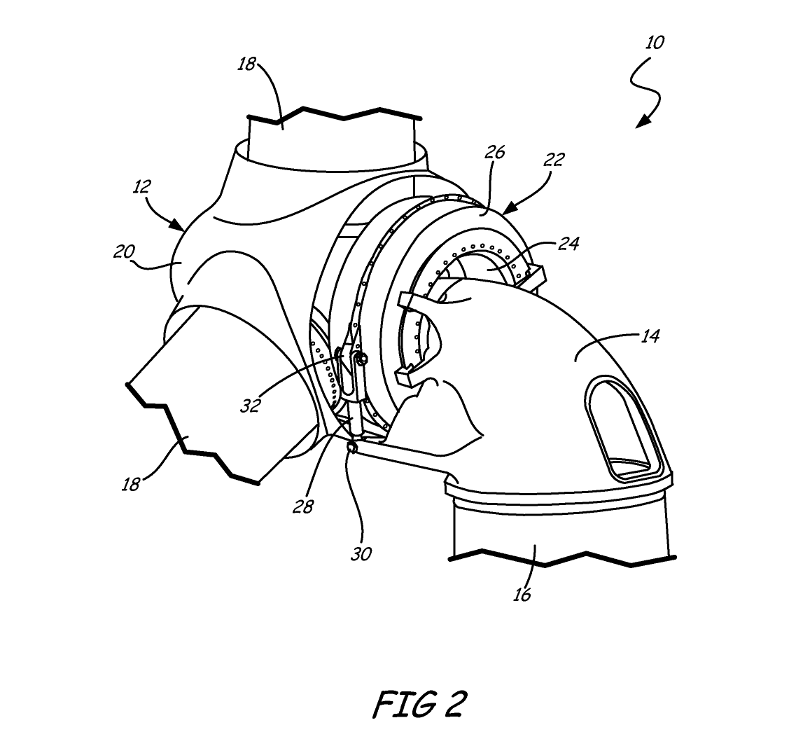

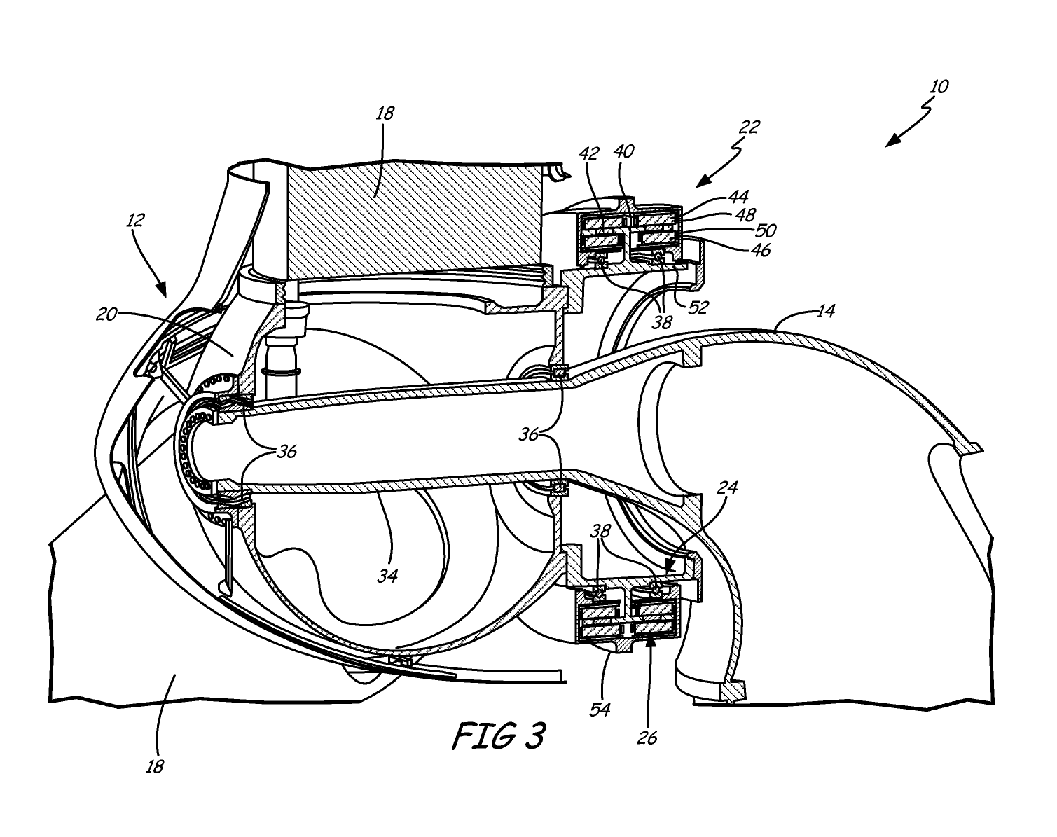

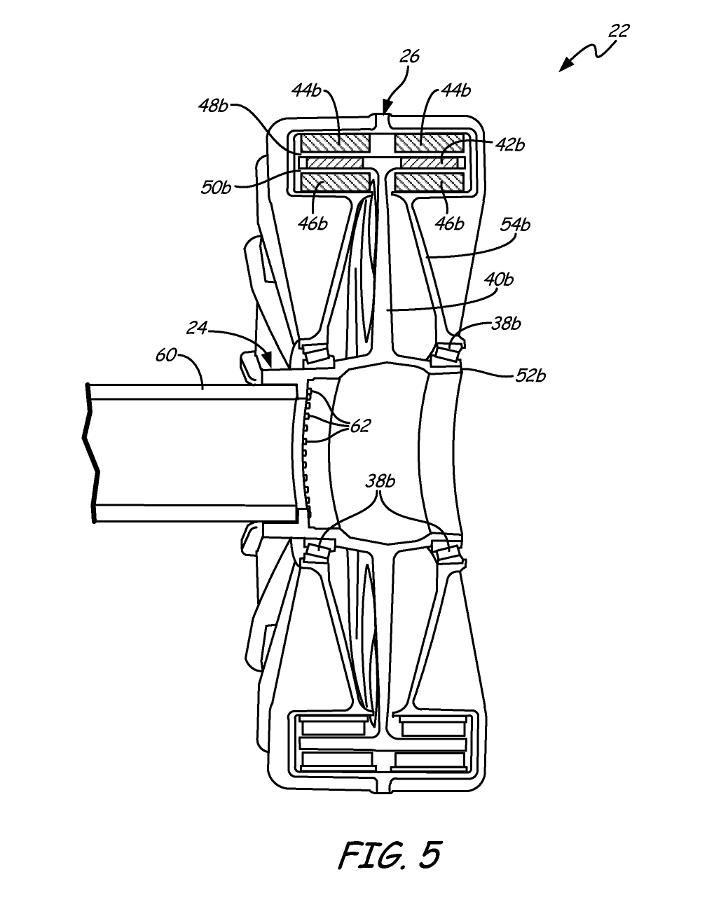

Blade assembly 12 is a rotating assembly mounted to support structure 14, atop tower 16. Blades 18 are airfoil structures formed, for instance, of fiberglass. Wind incident upon blades 18 applies a torque on hub 20 through blades 18. Hub 20 is a rotatable connecting section sharing a common axis with generator 22. Hub 20 receives blades 18, and can include pitching hardware capable of pitching blades 18 relative to incident wind. In the depicted embodiment, hub 20 is secured directly to a generator rotor (rotor 24; see FIGS. 2 and 3) of generator 22, such that rotation of hub 20 directly drives generator 22. In alternative embodiments, a driveshaft may transmit rotational load from hub 20 to generator 22 (see driveshaft 60 of FIG. 5). Although FIG. 1 depicts three blades 18, blade assembly 12 could alternatively be constructed in configurations with other numbers of blades.

Support structure 14 is a rigid gooseneck-shaped kingpin structure which anchors and supports blade assembly 12 and generator 22, and which may additionally provide housing for a subset of generator and power conversion components. Tower 16 is a tall, rigid structure that supports support structure 14. Tower 16 can be anchored at its base, for example, to a buried foundation or a floating off-shore platform. Tower 16 can also include ladders and/or elevators which provide personnel access from the base of tower 16 to support structure 14, as well as power cabling which transmits power to the base of tower 16 from generator 22, or from power conversion hardware located at the top of tower 16. Support structure 14 is movably connected to tower 16 via one or more yaw bearing rings (not shown) which allow support structure 14 and blade assembly 12 to turn to face the wind.

Generator 22 can be a direct-drive generator comprising rotor 24 and stator 26 (see FIGS. 2 and 3, below) driven by rotation of blade assembly 12. In some embodiments, rotor 24 may be a permanent magnet rotor, and stator 26 a wound stator. In alternative embodiments, rotor 24 may be a fed wound rotor. As set forth in greater detail below, stator 26 of generator 22 is supported on rotor 24, allowing the air gap of generator 22 to be made very small without risk of rotor 24 and stator 26 contacting as a result of deflection hub 20 and/or rotor 24.

FIG. 2 provides a perspective view of wind turbine 10 near the top of tower 16. FIG. 2 depicts blade assembly 12 (with blade 18 and hub 20), support structure 14, tower 16, generator 22, rotor 24, stator 26, torque reaction arm 28, torque reaction joint 30, and torque reaction joint 32.

As explained above with respect to FIG. 1, blades 18 are airfoil structures anchored to hub 20, which transfers torque from blades 18 to rotor 24 of generator 22. Support structure 14 supports generator 22 and blade assembly 12, and is in turn supported by tower 16.

Generator 22 can be a direct drive permanent magnet generator. In the depicted embodiment, both rotor 24 and stator 26 have large diameters selected to allow rotation of blade assembly 12 at normal wind speeds to produce fast relative motion between rotor 24 and stator 26, which are described in greater detail below with respect to FIG. 3. Rotor 24 is a rigid rotating structure affixed to hub 20 and driven by rotation of blade assembly 12. Rotor 24 may, for instance, be secured to hub 20 with bolts, pins, or screws. Rotor 24 can, for instance, be a permanent magnet rotor carrying a plurality of permanent magnets disposed along its outer diameter. In alternative embodiments, generator rotor 24 can be combined with hub 20 into an integrated rotor hub component. Stator 26 is a rigid structure mounted on rotor 24 via bearings (see FIG. 3), and carries a plurality of wound coils. The magnets of rotor 24 induce changing magnetic flux through the wound coils of stator 26 as rotor 24 rotates, thereby producing electrical power.

Stator 26 rides rotor 24, but is restrained against rotation by torque reaction arm 28, a rigid arm attached to both stator 26 and support structure 14. Torque reaction arm 28 is attached to support structure 14 via torque reaction joint 30, and to stator 26 via torque reaction joint 32. Torque reaction joints 30 and 32 are flexible connections with several degrees of freedom, and transmit only forces along the axis of torque reaction arm 28 (i.e. compression or tension of torque reaction arm 28), which is substantially tangent to the outer circumference of stator 26. Torque reaction arm 28 does not transmit bending moments from support structure 14 to stator 26. Stator 26 is thus free to move with small deflections of rotor 24 under transient aerodynamic loads, but is prevented from rotating together with rotor 24 by torque reaction arm 28. Although only one torque reaction arm 28 is shown in FIG. 2, some embodiments of wind turbine 10 may feature multiple torque reaction arms 28 to secure stator 26 against rotation. Although torque reaction arm 28 is shown as a rigid pole, torque reaction arm 28 may more generally take the form of any torque control element capable of securing stator 26 to support structure 14 in such a fashion as to allow stator 26 to deflect together with rotor 24, while preventing stator 26 from rotating. In some alternative embodiments, torque reaction arm 28 may, for instance, be replaced by paired torque reacting cables, chains, or belts disposed to oppose rotation in opposition directions about the axis of generator 22.

FIG. 3 is a cross-sectional view of wind turbine 10, illustrating blade assembly 12 (with blades 18 and hub 20), support structure 14 (with spindle 34 and blade assembly bearings 36), tower 16, and generator 22 (with rotor 24, stator 26, rotor bearings 38, magnet support 40, magnets 42, outer stator windings 44, inner stator windings 46, outer air gap 48, inner air gap 50, inner platform 52, and stator casing 54).

As described above with respect to FIGS. 1 and 2, blade assembly 12 rotates in response to wind incident on blades 18. In the depicted embodiment, rotor 24 is secured directly to hub 20, e.g. via bolts, pins, posts, screws, or rivets. Hub 20 rides spindle 34 via blade assembly bearings 36, which may for instance be cylindrical or tapered roller bearings. Spindle 34 is an elongated, substantially cylindrical portion of support structure 14, and accordingly does not rotate together with blade assembly 12 and rotor 24. Rotor 24 is not directly anchored to support structure 14, but is rather anchored to hub 20. In alternative embodiments, spindle 34 can be constructed in a conical shape, a box beam shape, an I-beam shape, or any other structurally appropriate beam shapes.

Rotor 24 comprises inner platform 52 and magnet support 40. Inner platform 52 is a substantially cylindrical bearing surface carrying rotor bearings 38. In alternative embodiments, inner platform 52 can, for instance, have a conical shape allowing for various diameter bearings 38. Magnet support 40 is an annular structure extending radially outward from inner platform 52 to support magnets 42 radially between outer and inner stator windings 44 and 46, respectively. In the depicted embodiment, magnet support 40 has a “T” cross-section, with a radial arm or web supporting an annular ring bearing magnets 42. In alternative embodiments, magnet support can, for instance, have a “U,” “J,” or “L” cross-section.

Stator casing 54 of stator 26 is a rigid body that surrounds, supports, and protects stator windings 44 and 46, and provides an attachment point for torque reaction arm 28, as depicted in FIG. 2. In the depicted embodiment, stator 26 comprises outer stator windings 44 and outer inner windings 46 axially aligned with magnets 42, and radially separated from magnets 42 by outer air gap 48 and inner air gap 50, respectively. Other stator winding configurations are also possible without deviating from the spirit of the present invention. Stator windings 44 and 46 are anchored to stator casing 54, which in turn rides stator bearings 52, thereby allowing rotor 24 to support stator 26 without rotating stator 26. Stator bearings 52 may, for instance, be ball, roller, or plain bearings. As described above with respect to FIG. 2, stator 26 is prevented from rotating together with rotor 24 by torque reaction arm 28 or an equivalent torque control element.

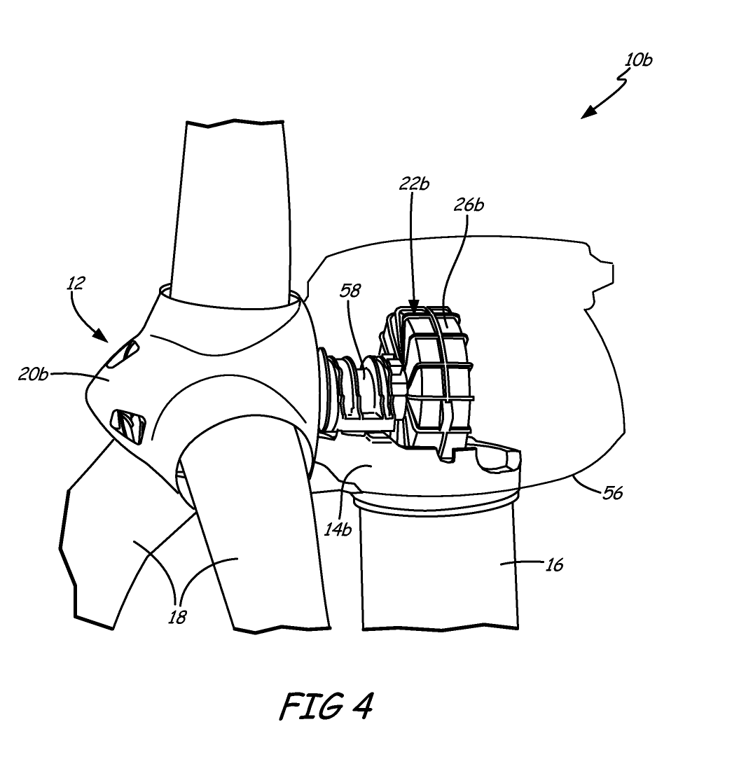

FIG. 4 is a perspective view of an alternative embodiment of wind turbine 10 labeled wind turbine 10b. Wind turbine 10b comprises blade assembly 12 (with blades 18 and hub 20b), support structure 14b, tower 16, generator 22b, stator 26b, nacelle 56, and shaft support 58. Wind turbine 10b operates in substantially the fashion described above with respect to FIGS. 1-3, except that hub 20b is connected to generator 22b via a driveshaft supported by shaft support 58, and not carried directly by support structure 14b. Support structure 14b lacks the gooseneck structure of support structure 14, with spindle 54. Instead, support structure 14b carries shaft support 58, a structure with bearings disposed to receive driveshaft 60 (see FIG. 5, described below). In the embodiment depicted in FIG. 4, wind turbine 10b further comprises nacelle 56, an environmental enclosure surrounding generator 22b and other peripheral components (e.g. power conversion hardware, diagnostic and measurement hardware, etc.). Although not depicted in FIGS. 1-3, wind turbine 10 can, in some embodiments, include a similar nacelle.

FIG. 5 is a cross-sectional view of generator 22b of wind turbine 10b, illustrating rotor 24, stator 26, stator bearings 38b, magnet support 40b, magnets 42b, outer stator windings 44b, inner stator windings 46b, outer air gap 48b, inner air gap 50b, inner platform 52b, stator casing 54b, driveshaft 60, and driveshaft fasteners 62.

As described above with respect to FIG. 4, generator 22b differs from generator 22 primarily in that rotor 24b is rotationally connected to hub 20b via driveshaft 60, rather than being directly secured to and supported on hub 20b. Rotor 24b and stator 26b otherwise function substantially as described above with respect to wind generator 10 (FIGS. 1-3), although the particular shapes of rotor 24b and stator 26b differ from corresponding rotor 24 and stator 26b.

Rotor 24b comprises inner platform 52b and magnet support 40b. Inner platform 52b is a substantially cylindrical structure that supports stator bearings 38b, and thereby carries stator 26b, much as described above with respect to generator 22. In alternative embodiments, inner platform 52b can, for instance, have a conical shape allowing for various diameter bearings 38b. Stator bearings 38b can, for instance, be ball, cylindrical, tapered roller, or plain bearings. Stator casing 54b supports outer and inner stator windings 44b and 46b, and extends radially outward from stator bearings 38b at inner platform 52b to situate outer stator winding 44b and inner stator winding 46b radially outward and inward of magnets 42b across outer and inner air gaps 48b and 50b, respectively. Inner platform 52b is secured to driveshaft 60 via driveshaft fasteners 62, which may for instance be bolts, pins, or screws. In alternative embodiments, generator rotor 24 can be combined with drive shaft 60 to minimize the number of wind turbine components.

Stator casing 54b is depicted with a radial taper which narrows from a maximum axial width at the radial location of stator windings 44b and 46b to a minimum axial width at the radial location of inner platform 52b. This tapered construction reduces the overall cost and weight of stator casing 52b. In other embodiments, however, stator casing 54b may take other forms designed to minimize unneeded mass while surrounding and supporting stator windings 44b and 46b. In some embodiments, particularly those eschewing nacelle 56 or equivalent protective structures, stator casing 54b (and/or equivalently stator casing 54) may protect magnets 42b and stator windings 44b and 46b from weather and other environmental conditions.

As described above with respect to wind turbine 10, and equivalently wind turbine 10b, magnets 42 can be permanent magnets. Magnets 42 can, for instance, be formed of neodymium or other rare earths. Magnets 42 can be substantially axially aligned with inner and outer stator windings 44 and 46, respectively. Alternatively, magnets 42 can be skewed relative to outer and inner stator windings 44 and 46 to reduce cogging. Similarly, stator windings 44 and 46 can be skewed relative to magnets 42 to reduce cogging.

Inner and outer stator windings 46 and 44 are conductive windings grouped in coils, and radially adjacent to magnets 42, and separated from magnets 42 by inner and outer air gaps 50 and 48, respectively. While generator 22 is in operation, magnet support 40 carries magnets 42 past inner and outer stator windings 46 and 44, inducing changing magnetic flux through stator windings 48 and 50, and thereby producing electric power. As shown in FIGS. 3 and 5, inner and outer stator windings 46 and 44 are arranged concentrically within stator casing 54 radially inward and outward, respectively, of permanent magnets 42.

By supporting stator 26 on inner platform 52 of rotor 24 with stator bearings 38, rather than on a stationary support structure such as support structure 14 as is conventional, generator 22 allows stator 26 to deflect together with (or “follow”) rotor 24 and hub 20 under transient aerodynamic loads. Deflecting together allows rotor 24 and stator 26 to avoid making contact even with very narrow air gaps 48 and 50. Accordingly, air gaps 48 and 50 can be reduced in width, increasing flux density and improving generator efficiency. The narrower air gaps made feasible by supporting stator 26 directly on rotor 24 also reduce the overall size and mass of generator 22, further decreasing production costs. Stator 26 is restrained against rotation, but not against deflection, by torque reaction arm 28 or equivalent torque control elements.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wind turbine comprising:
a support structure located atop a tower;
a rotatable blade assembly supported by the support structure;
a generator rotor driven by rotation of the rotatable blade assembly;
a generator stator supported by bearings on the generator rotor; and
a torque control element extending between the support structure and the generator stator to secure the generator stator against rotation while allowing the generator stator to deflect with the generator rotor under aerodynamic loads.

2. The wind turbine of claim 1, wherein the rotatable blade assembly comprises:
a rotatable hub coaxial with and rotationally connected to the generator rotor; and
a plurality of airfoil blades extending radially from the rotatable hub.

3. The wind turbine of claim 2, wherein the generator rotor is directly driven by the blade assembly.

4. The wind turbine of claim 3, wherein the generator rotor is directly attached to and supported by the blade assembly.

5. The wind turbine of claim 3, wherein the generator rotor is connected to the blade assembly via a driveshaft rotatably supported by the support structure.

6. The wind turbine of claim 1, wherein the torque control element is a torque reaction arm flexibly attached to the support structure and to the generator stator, such that the torque reaction arm transmits force only along an axis of the torque reaction arm substantially tangent to a circumference of the generator stator.

7. The wind turbine of claim 1, wherein the generator rotor is a two-sided permanent magnet rotor.

8. The wind turbine of claim 1, wherein the bearings are tapered roller bearings.

9. The wind turbine of claim 1, wherein the bearings are located at substantially the axial position of fore and aft extents of the generator stator.

10. The wind turbine of claim 1, wherein the generator rotor supports a plurality of permanent magnets.

11. The wind turbine of claim 10, wherein the permanent magnets are formed of neodymium.

12. The wind turbine of claim 1, wherein the support structure is gooseneck-shaped, with a substantially cylindrical spindle.

13. The wind turbine of claim 1, wherein the generator rotor comprises:
an inner platform supporting the bearings; and
an annular magnet support extending radially outward from the inner platform to carry a plurality of magnets adjacent to stator windings of the generator stator.

14. The wind turbine of claim 13, wherein the generator stator windings comprise concentric inner and outer stator windings radially inward and outward of the permanent magnets, respectively.

15. The direct drive wind turbine generator of claim 13, wherein the annular magnet support has a “T” cross-section.

16. A wind turbine generator comprising:
a wind-powered generator rotor carrying a plurality of permanent magnets;
a generator stator supported by bearings on the generator rotor, and carrying a plurality of generator stator windings; and
a torque control element securing the generator stator to a support structure in such a way as to prevent the generator stator from rotating, while allowing the generator stator to deflect with the generator rotor under aerodynamic loads.

17. The wind turbine of claim 16, wherein the generator stator is supported on the generator rotor by stator bearings, thereby allowing the generator rotor to rotate without rotating the generator stator.

18. The wind turbine of claim 17, wherein the generator stator bearings are ball bearings.

19. The wind turbine of claim 17, wherein the generator stator bearings are roller bearings.

20. The wind turbine of claim 16, wherein the generator stator bearings are mounted on an inner platform of the generator rotor, and the permanent magnets are mounted on an annular magnet support extending radially outward from the inner platform towards the plurality of generator stator windings.

21. The wind turbine of claim 20, wherein the bearings are situated at axial locations on the inner platform substantially corresponding to outer axial extents of the plurality of generator stator windings.

22. The wind turbine generator of claim 16, wherein the generator stator is a double-sided stator having outer stator windings disposed radially outward of the permanent magnets, and inner stator windings disposed radially inward of the permanent magnets.

23. The wind turbine of claim 15, wherein the torque control element is a torque reaction arm flexibly attached to the stationary structure and the generator stator, such that the torque reaction arm transmits force only along an axis of the torque reaction arm substantially tangent to a circumference of the generator stator.
